(19) United States
(12) Patent Application Publication
(10) Pub. No.: US 2013/0307299 A1
(43) Pub. Date: Nov. 21, 2013

(54) ADJUSTABLE SEAT POST ASSEMBLY FOR BICYCLES AND THE LIKE

(71) Applicants: Carl Winefordner, Laguna Beach, CA (US); Frank Hermansen, Laguna Beach, CA (US)

(72) Inventors: Carl Winefordner, Laguna Beach, CA (US); Frank Hermansen, Laguna Beach, CA (US)

(21) Appl. No.: 13/256,486

(22) PCT Filed: Nov. 5, 2010
(86) PCT No.: PCT/IB2010/055044

§ 371 Date: Aug. 9, 2013

(51) Int. Cl. B62J 1/08

(52) U.S. Cl. CPC B62J 1/08
USPC 297/215.13

(57) ABSTRACT

Adjustable seat post assembly for bicycles and the like, comprising a bushing (3), a quill (6) slidingly inserted in said bushing (3) and supporting the seat, jam means (8), inserted along said quill (6) and having a portion (9) which is pivotally coupled to said bushing (3). The jam means (8) are pivotable from an unlocked position, in which said quill (6) can freely slide inside said jam means (8) and relative to said bushing (3), to at least a locked position in which said jam means (8) blocks said quill (6) relative to said bushing (8) in at least one direction of displacement.

### FIELD OF THE INVENTION

The present invention concerns an adjustable seat post assembly for bicycles and the like.

More particularly, the present invention concerns an adjustable seat post assembly suitable for easily lower and rise the bicycle saddle while riding.

### STATE OF THE ART

Adjustable bicycle seat post assemblies are known which allow the rider to lower and raise their bicycle saddle while riding, especially when mountain biking.

Some of such known types of adjustable seat assemblies have a handlebar mounted release device, so the users do not need to move their hands away from the handlebar grips.

There are at least two main types of existing adjustable height seat posts: the first type is driven by an air/oil cylinder or similar device, the second type is driven by mechanical means, for example springs and the like.

Such existing adjustable seat post types have many technical disadvantages.

In fact, the air/oil driven type has numerous dynamic pressure seals, and contains oil and pressurized air, and valves. For this reason, these parts must be made of particular materials and with high precision.

Moreover, the height seat posts that use oil and pressurized air are especially unreliable, and often leak air and oil, and require rebuilding and seal replacements. Typically, these rebuilds are complex and require special non standard tools and fixtures, so the rider must mail their seat post to a warranty service center which requires time and money to fix. Plus, contamination including water and dirt can easily be thrown from the tire onto the seat post and lead to especially fast failures.

Air/oil adjustable height seat posts require many high precision highly machined components, and are very expensive to manufacture, often four or five time more costly than a standard high quality non-adjustable seat post.

Moreover, air/oil designs usually have somewhere between 75 and 100 mm of height adjustment range. In many cases, the rider would prefer to have a bigger height adjustment range, especially mountain bikers who ride down steep and rocky slopes.

Because of the sliding seals, air/oil designs typically use a metal such as aluminum, because such metal can be polished enough to work with dynamic seals and with oil. Carbon fiber, for example, would not work in this application.

Furthermore, in order for carbon fiber to be strong enough, the wall thickness must be increased compared to typically used aluminum alloys, and current air/oil designs do not have space to increase the wall sections.

Furthermore, existing air/oil designs have valves that are actuated through the seat post head, which prevents use of many types of seat post heads which are more preferred. They usually have an actuation cable that emanates from the seat post head, which means that the cable housing moves every time the seat post height is adjusted, causing the cable housing to need much room for this movement.

If the rider picks up the bicycle by the saddle, some existing air/oil designs allow the seat post to inadvertently move up and to suck air into a chamber causing a spongy feel until the air is pumped out: this is inconvenient.

Existing air/oil adjustable height seat posts cannot be scaled down enough to create a “27.2” mm sized seat post, a size that is extremely common in the market: existing air/oil designs can only be made down to about 30.9 mm in diameter, missing much of the world's potential market.

Some mechanical adjustable height seat posts have a series of holes drilled at various heights and a pin that locks into any one of the holes, but these holes severely weaken the seat post.

Another mechanical type has as expanding flange that locks into one of three internal groves inside a tube, but the mechanism is complicated and the internal groves cause stress riders in the tube.

Such mechanical assemblies usually include a high number of components, not including head components or the remote, which require extensive CNC machining, which is costly. Moreover, such components can fail over time.

Existing mechanical adjustable height seat posts have discrete height positions: some of them have about 10 positions with increments about 15 mm apart, while others have only 2 or 3 positions with increments about 50 mm apart.

Some mechanical designs also cannot be scaled down below 30.9 mm, while others are made in the 27.2 size, but these posts are weak, overly flexible, and probably do not pass testing. It is pointed out, in fact, that international test standards require certain strength and fatigue performances that most adjustable height seat posts cannot pass.

Existing designs fails because there are usually holes and/or notches and/or thin areas that severely weaken the seat posts, often in the areas of highest stress.

For this reason, existing mechanical designs cannot use carbon fiber for the main tubes because the drilling and notching required for these designs would cause failures.

Existing mechanical designs require a very strong spring force to overcome when adjusting the seat post height, which causes the rider to need to squeeze very hard to adjust the post height.

Every adjustable seat post must allow the rider to set up the seat post such that the height is correct when fully extended. The existing mechanical designs usually require that the rider disassemble a highly spring loaded mechanism which is both difficult and dangerous.

Most existing mechanical designs have an actuation cable that emanates from a midpoint of the seat post, which is better than from the head, but not as good as from a lower position.

More in general, adjustable seat posts with remote control, regardless of the type, usually weigh 600 to 650 grams total. This is around 400 grams more than standard high quality non adjustable height seat posts. So while adjustable height seat posts have many advantages, many cyclists will not install one on their bicycle because the weight increase is too much.

### AIM OF THE INVENTION

The technical aim of the present invention is therefore to improve the state of art and to overcome the cited drawbacks, providing an adjustable seat post assembly which is constructively and structurally simpler than other known types of adjustable assemblies.

Within such technical aim, a purpose of the present invention is to realize an adjustable seat post assembly which weighs substantially less than other known types of adjustable assemblies.

Another purpose of the present invention is to provide an adjustable seat post assembly which is inexpensive to manufacture, and which comprises a small number of components.

This aim is reached by an adjustable seat for bicycles and the like according to the attached claim 1.

The adjustable seat assembly according to the invention comprises very few components, which are easy and inexpensive to manufacture and assemble. In at least one of the embodiments described, the assembly comprises about half the components of a typical adjustable seat post of the known type.

The seat post assembly according to the present invention, when made of aluminum, weighs about 200 grams less than other adjustable height seat posts, and only about 200 grams more than standard high quality non adjustable height seat posts.

When the quill of the assembly and other parts are made of carbon fiber, the weight can be about 250 grams less than other adjustable height seat posts, and only about 150 grams more than standard high quality non adjustable height seat posts.

Furthermore, because there are no holes or notches or thin sections in the quill, the latter can be designed to use relatively little material.

The mechanism of the adjustable seat assembly according to the present invention is extremely simple and reliable in use.

Further advantageous characteristics are described in the dependent claims.

### BRIEF DESCRIPTION OF THE DRAWINGS

These and further advantages will be better understood by any man skilled in the art from the description that follows and from the attached tables of drawings, given as a non-limiting example, in which:

FIG. 1 is a perspective view of the adjustable seat post assembly installed into a bicycle frame, fully raised and in the locked position;

FIG. 2 is a perspective view of the adjustable seat post assembly, fully lowered and in the locked position;

FIG. 3 is a perspective view of the adjustable seat post assembly, substantially at mid height and with the height ring adjusted at maximum position;

FIG. 4 is a perspective view of the adjustable seat post assembly, substantially at mid height and with the height ring adjusted to a middle position;

FIG. 5 is a perspective view of the adjustable seat post assembly, substantially fully lowered and with the height ring adjusted at maximum position;

FIG. 6 is a perspective view of the adjustable seat post assembly, fully lowered and with the height ring adjusted to a middle position;

FIG. 7 is a lateral view of the adjustable seat post assembly, in the locked position;

FIG. 8 is a cross section of the adjustable seat post assembly realized according to plane VIII-VIII of FIG. 7;

FIG. 9 is a cross section of the adjustable seat post assembly realized according to plane IX-IX of FIG. 7;

FIG. 10 is a cross section of the adjustable seat post assembly realized according to plane X-X of FIG. 7;

FIG. 11 is a cross section of the adjustable seat post assembly realized according to plane XI-XI of FIG. 7;

FIG. 12 is a front view of the adjustable seat post assembly, in the locked position;

FIG. 13 is a cross section of the adjustable seat post assembly, realized according to plane XIII-XIII of FIG. 12;

FIG. 14 is a detailed vertical cross section of the adjustable seat post assembly, in the unlocked position;

FIG. 15 is an exploded view of the adjustable seat post assembly;

FIG. 16 is a detailed perspective view of another embodiment of the adjustable seat post assembly according to the invention, fully raised and in the locked position;

FIG. 17 is a perspective view of the adjustable seat post assembly according to the embodiment of FIG. 16, substantially at mid height and with the height ring at maximum position;

FIG. 18 is a perspective view of the adjustable seat post assembly according to the embodiment of FIG. 16, fully raised and with the height ring adjusted to limit the full height;

FIG. 19 is an exploded view of another embodiment of the adjustable seat post assembly according to the invention;

FIG. 20 is a detailed perspective view of the adjustable seat post assembly according to the embodiment of FIG. 19, fully raised;

FIG. 21 is a vertical cross section of the adjustable seat post assembly according to the embodiment of FIG. 19, in the locked position;

FIG. 22 is a detailed perspective view of another embodiment of the adjustable seat post assembly according to the invention;

FIG. 23 is a detailed perspective view of another embodiment of the adjustable seat post assembly according to the invention;

FIG. 24 is a detail of FIG. 23;

FIG. 25 is a detailed perspective view of another embodiment of the adjustable seat post assembly according to the invention;

FIG. 26 is a perspective view of another embodiment of the adjustable seat post assembly according to the invention, fully raised and in the locked position;

FIG. 27 is a front view of the adjustable seat post assembly according to the embodiment of FIG. 26;

FIG. 28 is a vertical cross section of the adjustable seat post assembly according to the embodiment of FIG. 26, in the locked position;

FIG. 29 is a perspective view of another embodiment of the adjustable seat post assembly, fully raised and in the locked position;

FIG. 30 is a front view of the adjustable seat post assembly according to the embodiment of FIG. 29, in the locked position;

FIG. 31 is a vertical cross section of the adjustable seat post assembly according to the embodiment of FIG. 29, in the locked position;

FIG. 32 is a front view of another embodiment of the adjustable seat post assembly, fully lowered;

FIG. 33 is a side view of the adjustable seat post assembly of FIG. 32;

FIG. 34 is a diametrical cross section of the adjustable seat post assembly of FIGS. 32,33;

FIG. 35 is a diametrical cross section of the adjustable seat post assembly of FIGS. 32-34, fully raised;

FIG. 36 is a detail of FIG. 35;

FIG. 37 is a perspective exploded view of the adjustable seat post assembly of FIGS. 32-36;

FIG. 38 is a diametrical cross section of the adjustable seat post assembly of FIGS. 32-37, adjusted to shorten the overall length of the seat post;

FIG. 39 is a cross section of the adjustable seat post assembly of FIGS. 32-38 realized according to plane XXXIX-XXXIX of FIG. 32;

FIG. 40 is a diametrical cross section of another embodiment of the adjustable seat post assembly according to the invention, fully raised;

FIG. 41 is a detailed diametrical cross section of the adjustable seat post assembly of FIG. 40, in an intermediate position;

FIG. 42 is a diametrical cross section of another embodiment of the adjustable seat post assembly according to the invention, in an intermediate position;

FIG. 43 is a detail of FIG. 42;

FIG. 44 is a detailed perspective view of a bicycle frame provided with the adjustable seat post assembly according to FIGS. 43,44;

FIG. 45 is a detailed diametrical cross section of another embodiment of the adjustable seat post assembly according to the invention, in an intermediate position;

FIG. 46 is a detailed diametrical cross section of another embodiment of the adjustable seat post according to the present invention;

FIG. 47 is a detailed diametrical cross section of another embodiment of the adjustable seat post assembly according to the present invention.

### EMBODIMENTS OF THE INVENTION

With reference to the representation of FIG. 1, an adjustable seat post assembly for bicycles and the like according to the invention is wholly indicated with reference numeral 1.

It is pointed out that in the following embodiments individual characteristics, given in connection with specific embodiments, may actually be interchanged with other different characteristics that exist in other embodiments.

As shown in FIG. 1, the post assembly 1 is installed in a bicycle frame 2, but it can be installed in frames of any other similar transport means as well.

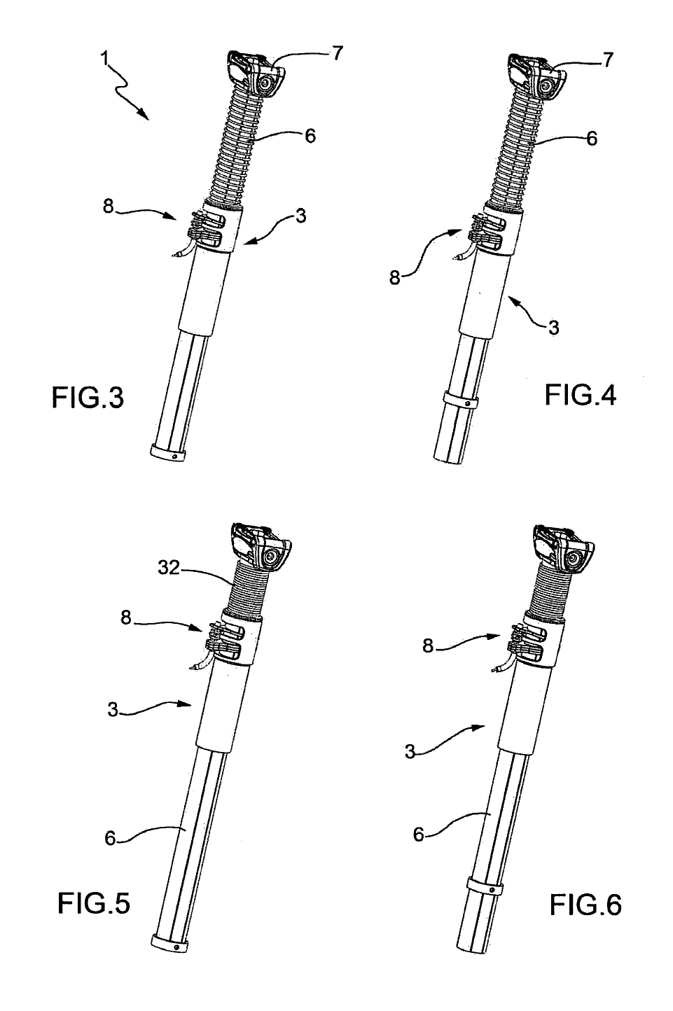

The assembly 1 according to the invention comprises a bushing, wholly indicated with 3 in FIGS. 3-6, suitable to be inserted in the frame's seat tube 4, and suitable to be fixed by means of a clamp 5, which is substantially traditional and known per se. A quill 6 is slidingly inserted in the bushing 3: the length of the quill 6 is obviously such as to allow the user to get the minimum or maximum height of the seat, to his liking. The quill 6 is provided with a head 7 on top: on the head 7 the seat of the bicycle, or of other similar transport means, is mounted with means known per se. Actually the seat is not represented in the attached drawings for the sake of simplicity, since any traditional and known type of seat can be mounted on the quill 6, with no limitations.

The assembly 1 comprises, furthermore, jam means, wholly indicated with 8, inserted along the quill 6 and having a portion 9 which is pivotally coupled to the bushing 3.

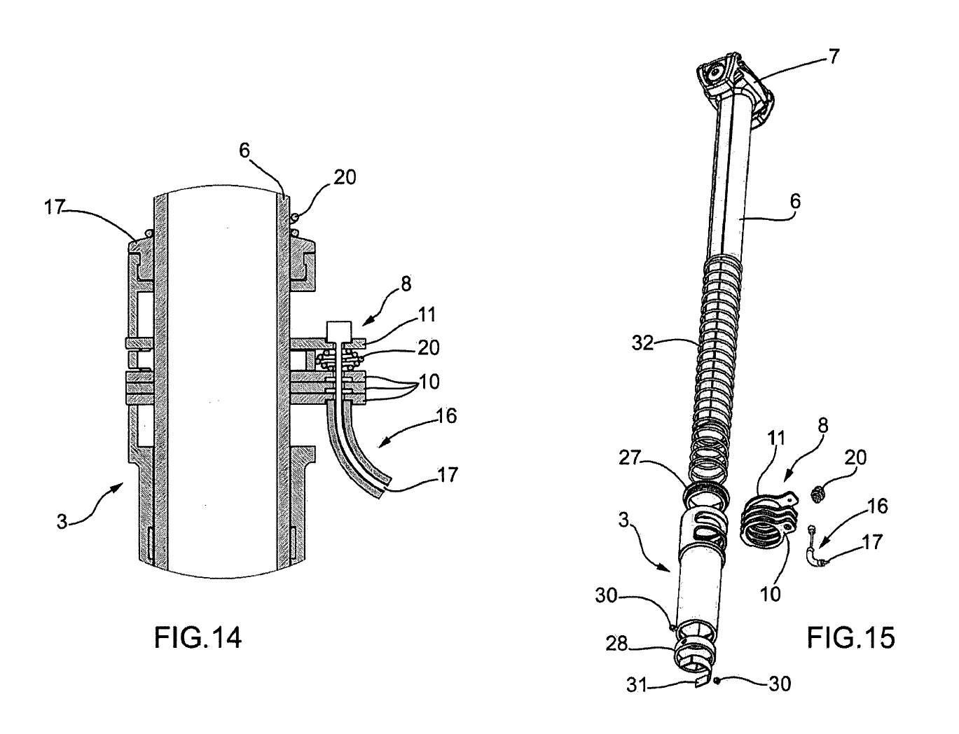

The jam means 8 comprises at least one jam ring 10,11 pivotable from an unlocked position, shown in FIG. 14, in which the quill 6 can freely slide inside the jam ring 10,11 and relative to the bushing 3, to a locked position, shown in FIG. 13, in which the jam ring 10,11 blocks the quill 6 relative to the bushing 3 in at least one direction of displacement.

More in detail, the jam means 8 comprises at least a first jam ring 10 pivotable from an unlocked position to a locked position, in which the first jam ring 10 blocks the quill 6 relative to the bushing 3 in the downward direction of displacement. As better explained in the sequel, in order to bear the user's weight, the assembly 1 comprises a group of said first jam rings 10, for example three first jam rings 10. Said first jam rings 10 are piled up along the quill 6, as shown, for example, in FIG. 13 and others.

The jam means 8 further comprises a second jam ring 11, which is also pivotable from an unlocked position, in which the quill 6 can freely slide inside the second jam ring 11 and relative to the bushing 3, to a locked position in which the second jam ring 11 blocks the quill 6 relative to the bushing 3 in an upward direction of displacement.

As shown in FIGS. 13 and 14, the first jam rings 10 and the second jam ring 11 are pivotable according to respective opposite directions from the unlocked position to the locked position, and vice versa.

More in detail, FIG. 13 shows the assembly 1 with the pile of first jam rings 10 and the second jam ring 11 in the respective locked positions. In this locked positions, thanks to a jamming action, the pile of first jam rings 10 prevent the quill 6 from moving downwards, even when the user sits on the seat, and the second jam ring 11 prevents the quill 6 from moving upwards.

As it can be seen particularly in FIG. 9, the pivoting portion 9 of each of the first jam rings 10 and of the second jam ring 11 comprises a sort of circular segment 12, having a radius which is bigger than the radius of the jam rings 10,11.

The first jam rings 10 and the second jam ring 11 comprise respective internal flat borders 13, whose function will appear clearer in the sequel.

Furthermore, each of the first jam rings 10 and the second jam ring 11 comprise an operation portion 14, which is opposite to the pivoting portion 9.

The operation portion 14 of each of the first jam rings 10 and of the second jam ring 11 comprises connecting means 15 to a remote control device 16 of the adjustable seat assembly 1. Such remote control device 16 allows the user to set the height of the seat while riding, by operating the first jam rings 10 and the second jam ring 11, as better explained in the sequel.

The connecting means 15 comprise, in each of the first jam rings 10 and in the second jam ring 11, a hole provided in the operation portion 14.

The remote control device 16 of the adjustable seat assembly 1 comprises an operation cable 17, passing through the holes 15 of the first jam rings 10 and of said second jam ring 11. The operation cable 17 has a head 18 resting on the operation portion 14 of the second jam ring 11, and a sheath 19 whose end rests on the operation portion 14 of the lower of the first jam rings 10.

The remote control device 16 further comprises an operation spring 20, provided between the upper of the first jam rings 10 and the second jam ring 11, inserted along said operation cable 17. As shown in FIG. 13, the operation spring 20 of the remote control device 16 keeps the first jam rings 10 and the second jam ring 11 in the respective locked positions.

The remote control device 16 comprises any means—not shown because of the well known type, for example a lever—provided preferably on the handlebar, suitable to pull the operation cable 17, in order to pivot the first jam rings 10 and the second jam ring 11 from the locked position to the unlocked position.

The bushing 3 comprises, along its back portion, a first slot 21 in which the pivoting portions 9 of the first jam rings 10 are engaged. The bushing 3 further comprises a second slot 22 in which the pivoting portion 9 of the second jam ring 12 is engaged.

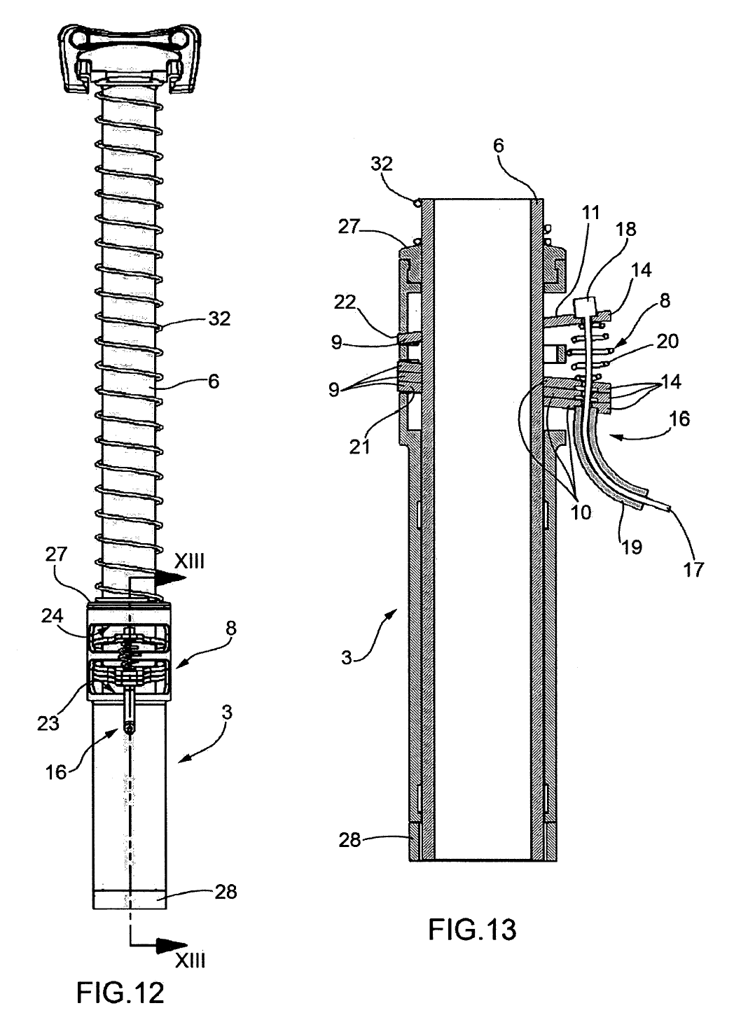

As shown in FIG. 12, the bushing 3 comprises, in its front portion, a first opening 23 for the operation portions 14 of the first jam rings 10. The bushing 3 further comprises a second opening 24 for the operation portion 14 of the second jam ring 11.

The bushing 3 comprises two opposite substantially flat internal surfaces 25. Correspondingly, the quill 6 comprises two opposite substantially flat external surfaces 26, coupled to the flat internal surfaces 25 of the bushing 3 in order to prevent rotation between the bushing 3 and the quill 6. The flat external surfaces 26 of the quill 6 are also coupled to the internal flat borders 13 of the first jam rings 10 and of the second jam ring 11, in order to prevent rotation between the quill 6 an the jam rings 10,11.

The assembly 1 comprises a bushing wiper 27 mounted on top of the bushing 3, shown for example in FIG. 15 and others.

The assembly 1 further comprises a height ring 28 provided along the quill 6, suitable to selectively adjust the maximum height of the seat. Said height ring 28 comprises two opposite passing threads 29, provided in two flat internal surfaces 29a, for two respective set screws 30, which are suitable to engage the flat external surfaces 26 of the quill 6. A protective liner 31 is mounted inside the height ring 28.

The assembly comprises a seat spring 32, inserted along the quill 6, suitable to determine the displacement of the quill 6 in at least one direction, particularly the upward direction.

The seat spring 32 is provided between the bushing wiper 27 and the head 7 of the quill 6. Consequently, when the jam means 8 are in the unlocked position, the seat spring 32 pushes the quill upwards.

FIGS. 3 and 5 respectively show the assembly 1 with the seat at a mid height position and at minimum position, and with the height ring 28 adjusted at maximum position, by the lower end of the quill 6.

FIGS. 4 and 6 respectively show the assembly 1 with the seat at a mid height position and at minimum position, and with the height ring 28 adjusted to a middle position.

The user can of course adjust the height ring 28 to any intermediate position along the quill 6 operating on set screws 30, obtaining a different customized maximum position.

In practical use, to adjust the seat's height, the user operates the remote control device 16 while riding the bicycle. The operation of the remote control device 16 contracts operation cable 17, which on turn causes the rotation of the first jam rings 10 and of the second jam ring 11 from the locked position to the unlocked position. In this situation, the seat spring 32 pushes upwards the quill 6, setting the seat at a higher position, until the user releases the remote control device 16.

In the same way, after getting the jam means 8 in the unlocked position, the user can push down the quill 6 with his weight, setting the seat a lower position until the user releases the remote control device 16.

It can be seen that the invention reaches the proposed purposes, and achieves many technical advantages.

In the first place, the adjustable seat assembly according to the invention is simple and reliable, with very few components required, and all components are easy and inexpensive to manufacture and assemble. The embodiment described has fifteen components, about half the components of a typical prior art adjustable seat post, and only ten components are different, because some are repeats.

Furthermore, the assembly according to the invention weighs sensibly less than other typical prior art seat post assemblies.

Since the quill 6 of the assembly does not have any holes, or notches, or thin sections that can cause early failure, the assembly according to the invention passes any international strength test standard.

For the same reason, the design of the quill 6 can be scaled down, to fit for example a 27.2 mm diameter seat post, and still be strong enough.

The disassembly and assembly of the adjustable seat is simple, and does not require any special tools or skills.

The adjustment of the seat height has infinite position within the minimum-maximum range.

The design of the quill 6 may use many materials, including steel, different aluminum alloys, titanium, and carbon fiber.

The mechanism of the assembly is independent of the quill head 7, so the latter can be of any design.

The operation cable 17 emanates very low, close to the bicycle frame's seat tube. This allows the cable sheath to run along the frame's top tube.

The saddle of the bicycle cannot be inadvertently pulled up, because the quill 6 is locked from moving both up and down.

Finally, a low force is required to activate the remote control device 16, enough to compress the operation spring 32.

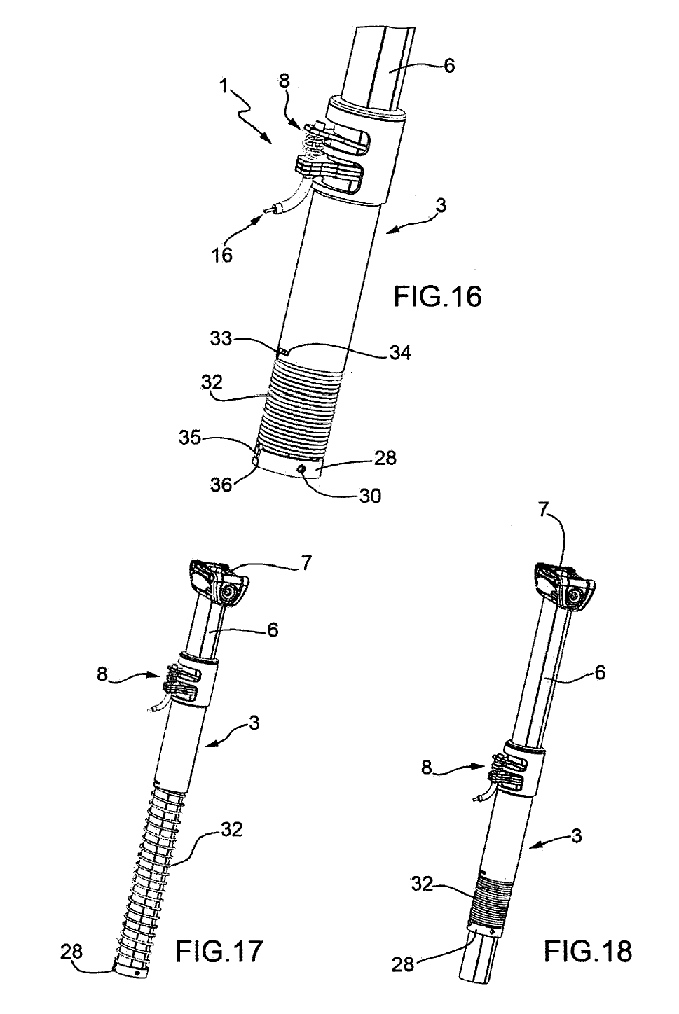

Another embodiment of the adjustable seat assembly according to the invention is shown in FIGS. 16-18.

In such figures, and in the description that follows, the parts corresponding to those described in the preceding embodiment are indicated with the same reference numerals.

In this embodiment of the invention, the seat spring 32 is provided between the bushing 3 and the height ring 28.

The seat spring 32 has a first end 33 engaged in a first housing 34 provided in the bushing 3, and a second end 35 engaged in a second housing 36 provided in the height ring 28.

In this embodiment, the seat spring 32 is advantageously hidden inside the frame's seat tube, which protects the seat spring 32 from contamination and environmental elements; furthermore this feature prevents any pinch points within the seat spring 32. Seat spring 32 is an extension spring, so with the jam means 8 in the unlocked position, the spring 32 itself pulls the quill 6 upwards.

Another embodiment of the adjustable seat assembly according to the invention is shown in FIG. 22.

The present embodiment differs from the previous one in the fact that the seat spring 32 has a first end 33 screwed on to a first helical groove 37 provided in the bushing 3, and a second end 35 screwed on to a second helical groove 38 provided in the height ring 28.

In this embodiment the seat spring 32 is secured to the bushing 3 and to the height ring 28 in a safer way: the seat spring 32 cannot unthread from the height ring 28 or from the bushing 3 because the quill 6 prevents the height ring 28 and the bushing 3 from turning.

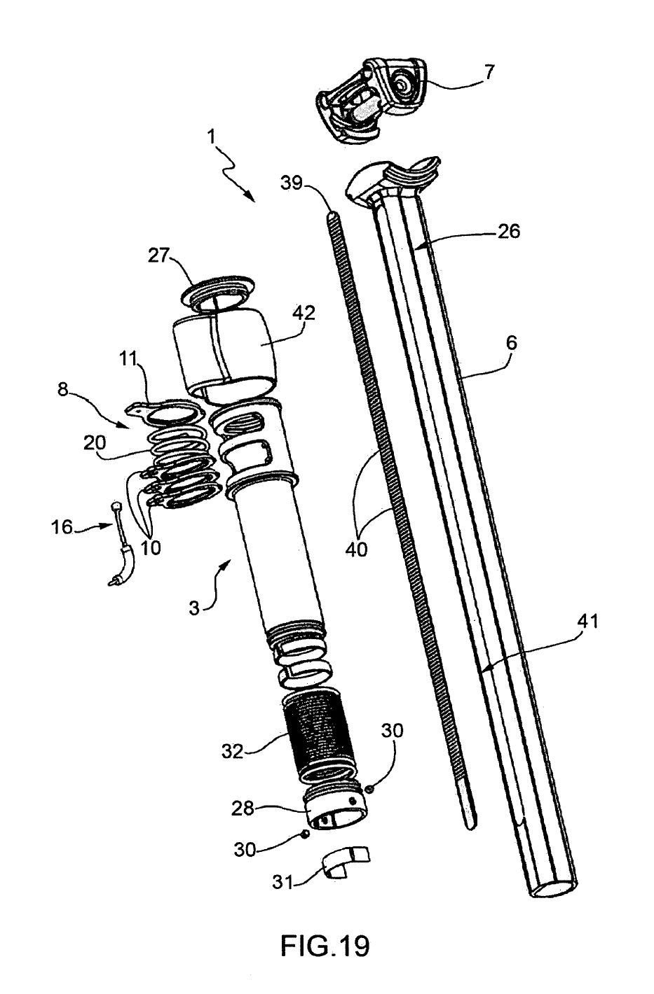

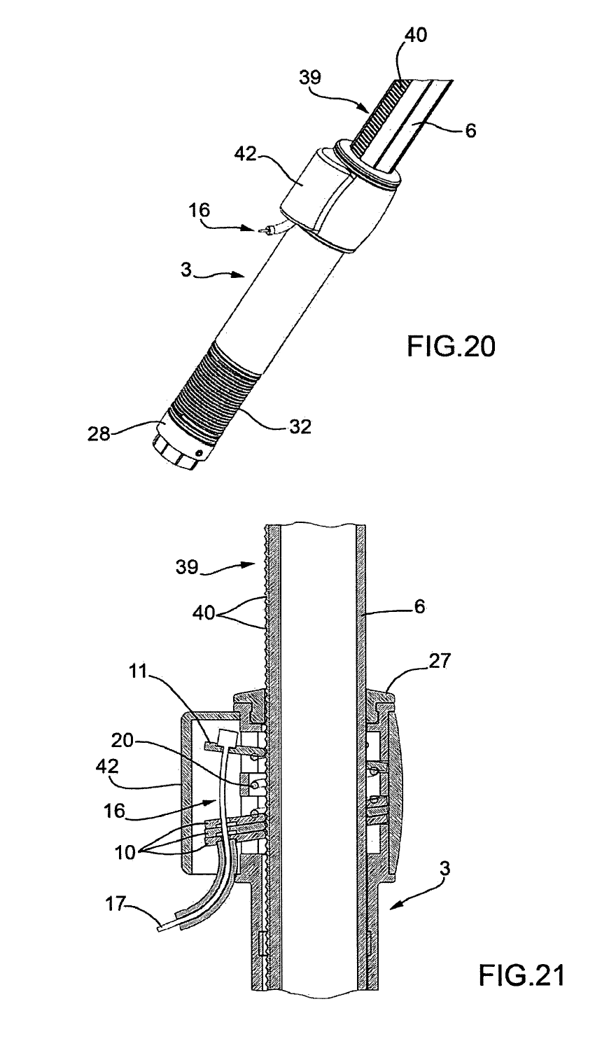

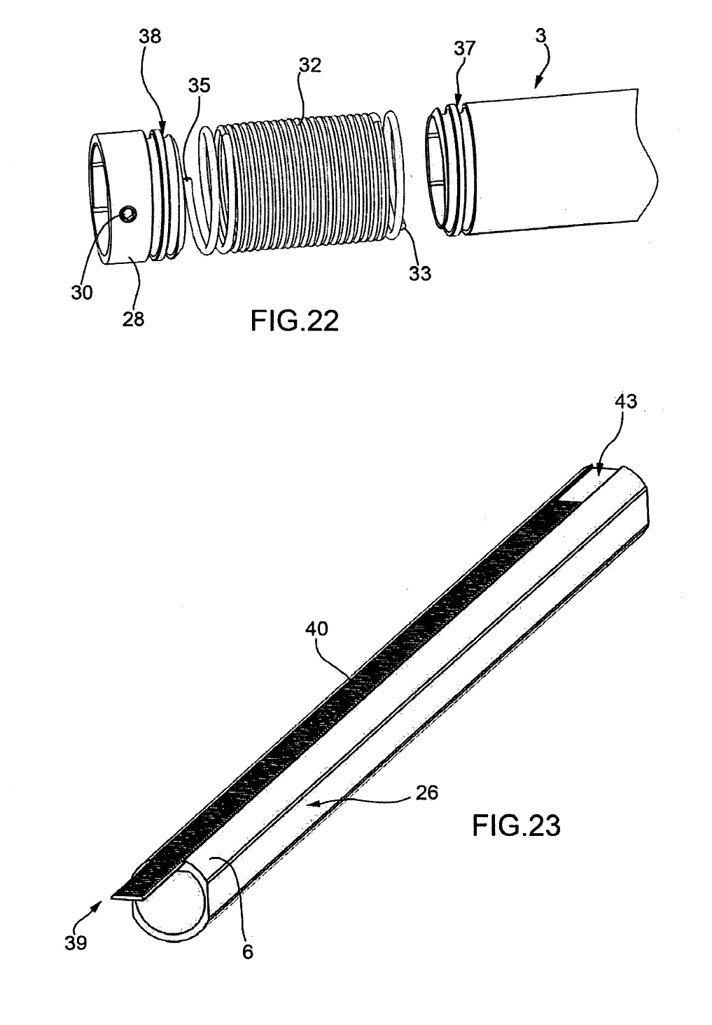

Another embodiment of the adjustable seat post assembly according to the invention is shown in FIGS. 19-21.

In such figures, and in the description that follows, the parts corresponding to those described in the preceding embodiment are indicated with the same reference numerals.

This embodiment differs from the previous ones primarily in the fact that it comprises a jam strip 39 mounted on the external surface of the quill 6: the jam strip 39 is provided with a plurality of transversal grooves 40 suitable to be engaged by the jam means 8.

This feature offers several improvements.

In fact, it allows greater material choices. Some materials, such as grades of steel, would make an excellent jam contact surface but would be heavy if used for the entire quill 6. In this way, the quill can be made of a low density high strength material such as aluminum or carbon fiber, while the jam strip 39 is made of steel, brass, aluminum, plastic, or other suitable material.

Furthermore, this feature reduces stress risers: the jam strip 39 can have grooves 40 without causing stress risers in the quill 6.

The jam strip 39 could also be made without grooves, and if the jam rings 10,11 causes small notches or indentations of the surface of the jam strip 39, there is no stress risers in the quill 6.

Moreover, this feature potentially reduces cost, especially if the jamming surface has grooves. For example, there are numerous low cost methods to create grooves in the jam strip 39, whereas it would be more expensive to create grooves directly in the quill 6.

Finally, the jamming surface could potentially wear with use, and it is much less costly to replace the jam strip 39 than to replace the entire quill 6.

As shown in FIG. 19, the jam strip 39 is engaged in a longitudinal closed slot 41 provided in the quill 6. After assembly, the jam strip 39 is captured and is prevented from moving relative to the quill 6 by the slot 41.

Furthermore, in this embodiment the assembly 1 comprises a cover 42 for the jam means 8. The cover prevents water and other impurities from contaminating the jam means mechanism. The cover 42 can, for example, be made of a material that seals, such as silicon rubber.

In this embodiment, the operation spring 20 of the remote control device 16 is provided between the first jam rings 10 and the second jam ring 11, inserted along the quill 6.

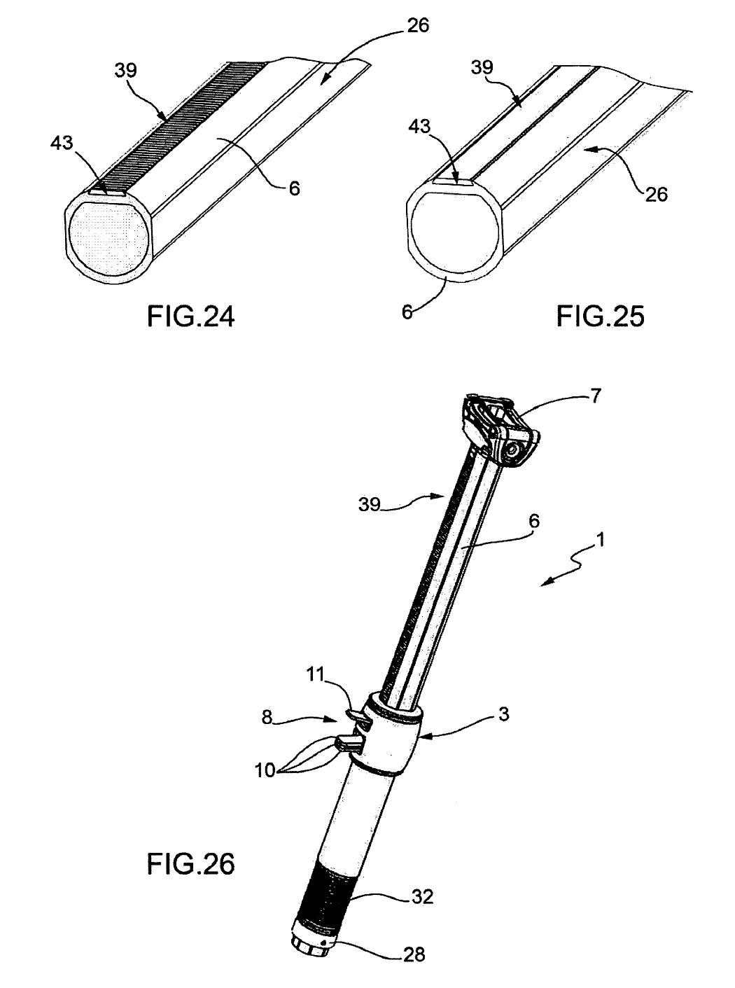

Another embodiment of the adjustable seat assembly according to the invention is shown in FIGS. 23-24.

In this embodiment, the jam strip 39, having a plurality of transversal grooves 40, is engaged in a longitudinal open groove 43 provided in the quill 6. More in detail, the jam strip 39 is engaged in the longitudinal groove 43 of the quill 6 with a dovetail coupling, as shown in FIG. 24.

For manufacturing, the quill 6 can for example be easily extruded in this shape and have a head bond and/or press fit onto one end of the quill 6. The jam strip 39 can be bonded into place, secured with a set screw, press fit, or held in place by many possible methods.

Another embodiment of the adjustable seat assembly according to the invention is shown in FIG. 25.

In this embodiment, the jam strip 39 has a smooth surface. In this way, the jam strip 39 can be made of a material that is softer than the jam rings 10,11, wherein the jam rings 10,11 would cause small indentations in the jam strip 39 creating and extremely positive jamming action, and without causing stress risers in the quill 6. In that case, the jam strip 39 should ideally be made of a material that can withstand notching without cracking, i.e. a non-notch sensitive material.

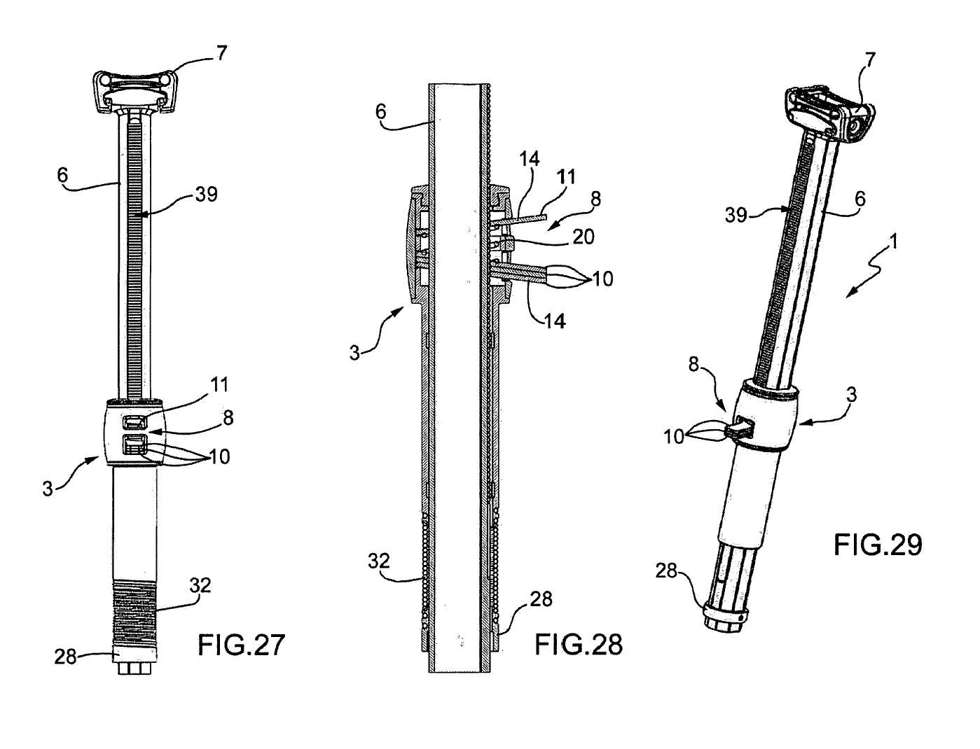

Another embodiment of the adjustable seat assembly according to the invention is shown in FIGS. 26-28.

In this embodiment the first and second jam rings 10,11 do not have any connecting means to the remote control device. In other words, the bicycle has no remote control device for the adjustable seat assembly 1.

Therefore, no holes are provided in the operating portions 14 of the first and second jam rings 10,11. The jam means 8 are then manually operated by the user, squeezing together the jam rings 10,11.

The operation spring 20 is provided between the first jam rings 10 and the second jam ring 12.

No cover of the jam rings 10,11 is provided, to allow manual operation.

This embodiment is less convenient to use, because the rider must remove a hand from the handlebar to operate the jam means 8, but it still offers several improvements.

In fact, the design is further simplified, as no remote control device is required.

The assembly weighs less, as a remote control device usually weighs at least 50 grams. The cost is also lower, since no remote control device is required.

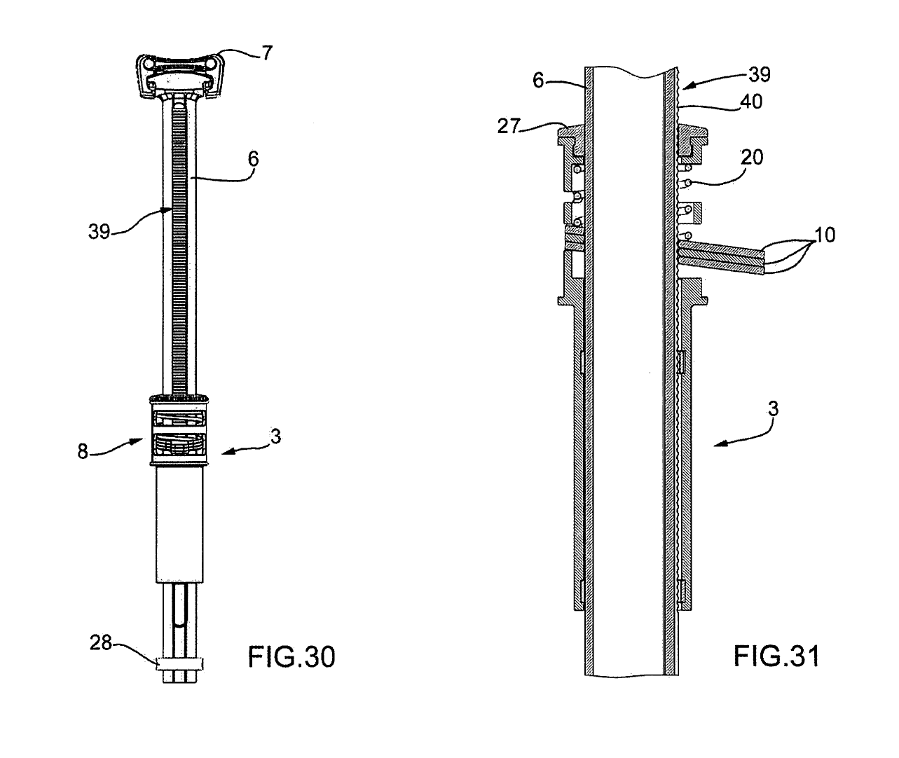

Another embodiment of the adjustable seat assembly according to the invention is shown in FIGS. 29-31.

In this embodiment, the jam means 8 comprises only a group of first jam rings 10 which, in the locked position shown in FIG. 31, prevent the quill 6 to move downwards.

No seat spring is provided. The operation spring 20 is provided between the upper first jam ring 10 and the bushing 3.

For use, the rider would manually pull up the first jam rings 10, and the weight of the quill 6 and seat would cause the seat to lower. To rise the seat, the rider simply pulls up on the seat, because there is no second jam ring to prevent upward movement.

The design of the present embodiment is further simplified, since components like the second jam ring, the remote control device and the seat spring are not required.

The weight and cost are consequently further reduced.

The seat spring 32 of the described embodiments can be replaced by any other kind of spring, for example an air spring.

The surface of the jam strip 39 of the described embodiments can be of any other kind, for example it can be a rough texture that increases friction with the jam rings 10,11.

Any other intermediate jamming component can be provided between the jam rings 10,11 and the quill 6, or between the jam rings 10,11 and the jam strip 39.

Obviously, the number of the jam rings 10,11 of the described embodiment can be any, according to any specific design requirement.

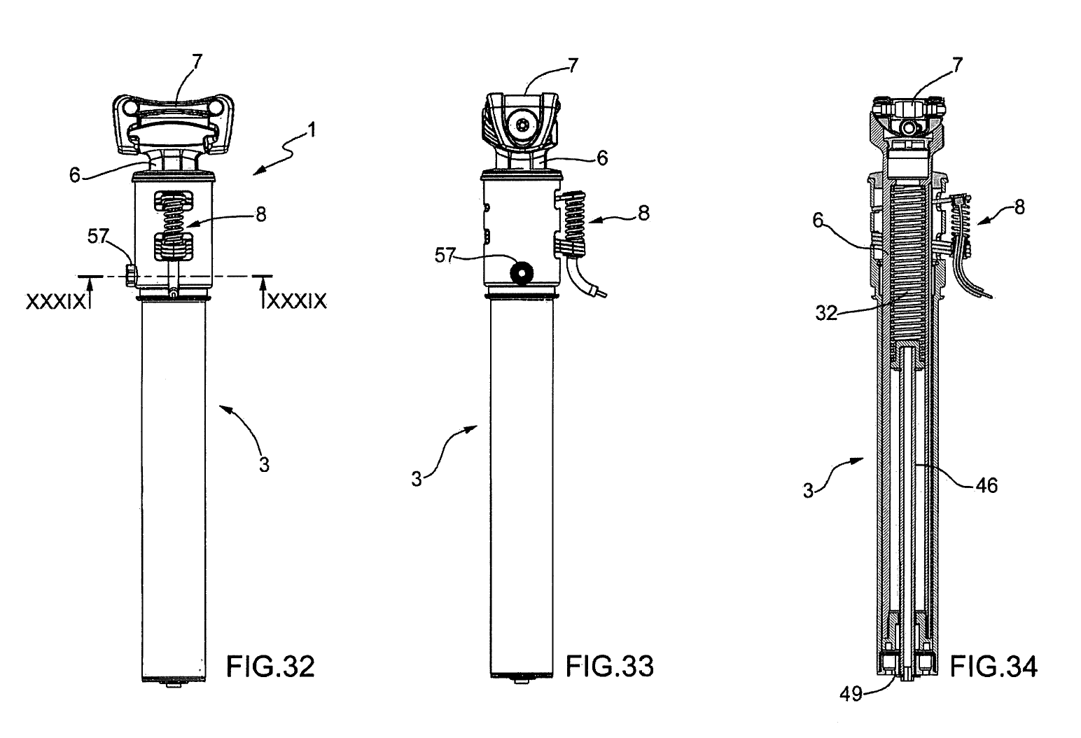

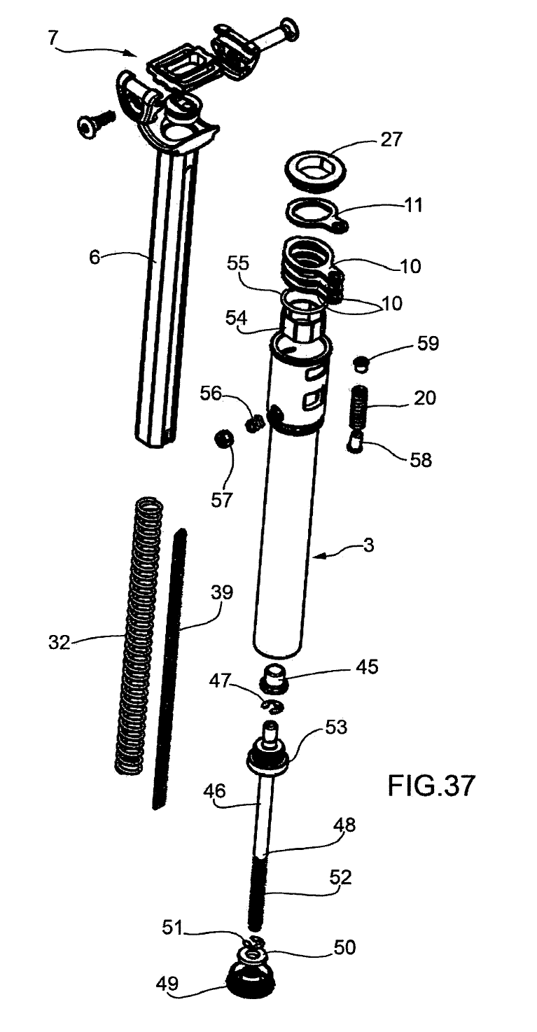

Another embodiment of the adjustable seat post assembly according to the invention is shown in FIGS. 32-39. In such figures, and in the description that follows, the parts corresponding to those described in the preceding embodiment are indicated with the same reference numerals.

In this embodiment, the seat spring 32 is contained within the quill 6, in order to obtain a cleaner and safer construction of the post assembly 1. In fact, this solution prevents accidental pinching of the seat springs 32 on user's skin, or clothes; furthermore, this solution helps keeping the whole assembly 1 clean from dust and filth, which won't accumulate on the seat spring 32.

In this embodiment, the seat spring 32 has an upper end resting on an internal collar 44 of the quill 6, and a lower end resting on a head 45 of a stem 46 housed inside the bushing 3. A retainer ring 47 mounted by the upper end of the stem 46 limits the stroke of the quill 6 itself in the upper position.

The stem 46 has a lower extremity 48 coupled to an end cap 49 fixed at the lower end of the bushing 3 with a bumper 50 and a retainer ring 51. More particularly, the lower extremity 48 has an external thread 52 which is screwed in a passing thread of the end cap 49.

The quill 6 has a lower bushing 53 provided with a passing hole, in which the stem 46 is slidingly engaged.

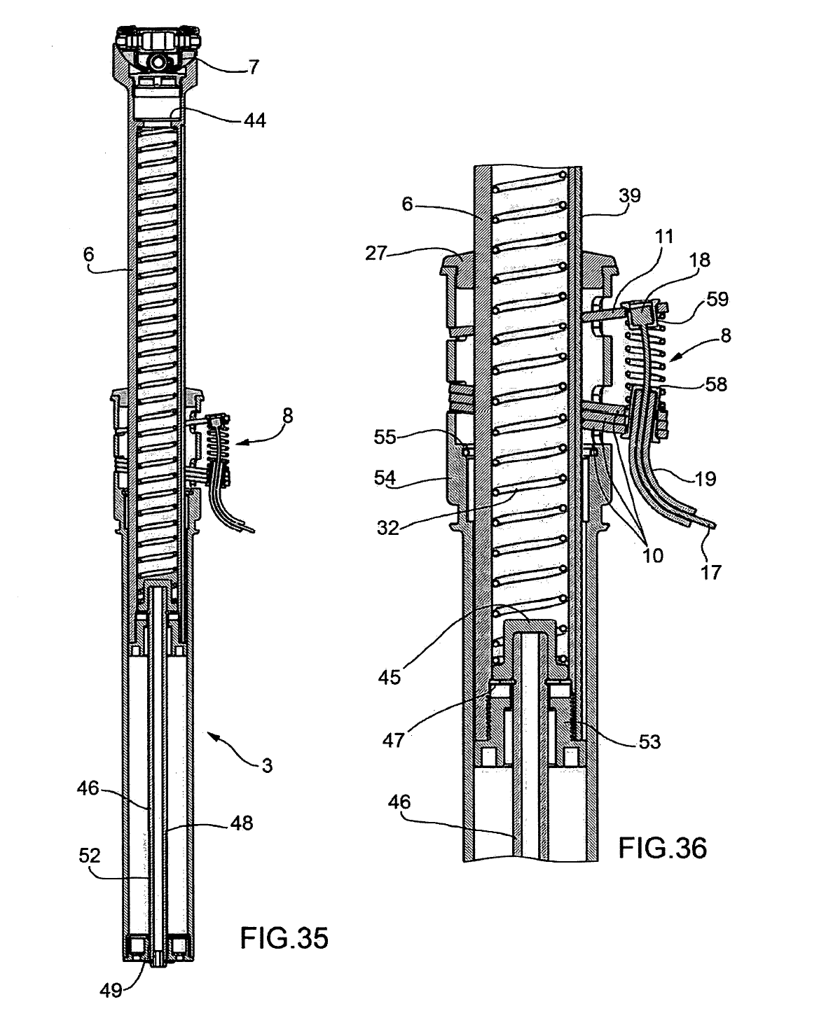

FIGS. 32-34 show the post assembly 1 in a fully lowered position; FIG. 35 shows the same post assembly 1 in a fully raised position. In both said positions, the jam means 8 are in their locked position.

The quill 6 is provided with a jam strip 39, on which the jam means 8 engage when they are in the locked position, as better shown in FIG. 36.

The bushing 3 is provided with a bushing wiper 27 and with a further internal bushing wiper 54 fixed with a retainer ring 55; the bushing wiper 27 and the internal bushing wiper 54 are both provided with flat internal surfaces which guide the quill 6 in its stroke and prevent the same from rotating around its axis.

Furthermore, the bushing 3 is provided with a set screw 56 engaged in a jam nut 57, better shown in FIG. 39. The set screw 56, which engages on the surface of the internal bushing wiper 54, allows the user to adjustably increase the friction, to control the quill speed 6 during adjustment, as the internal bushing wiper 54 wears with use.

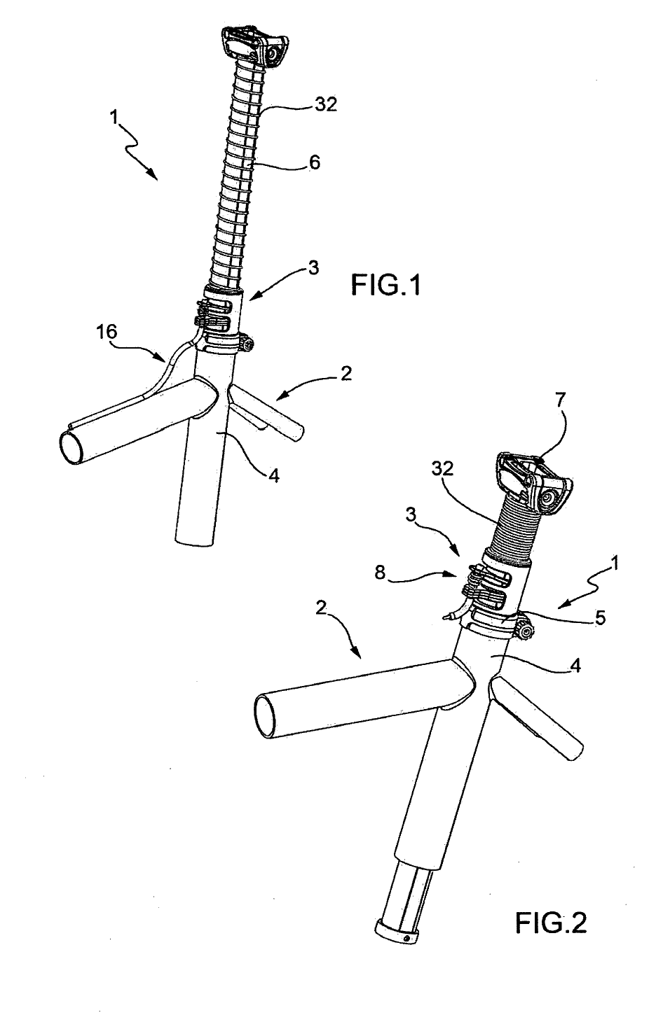

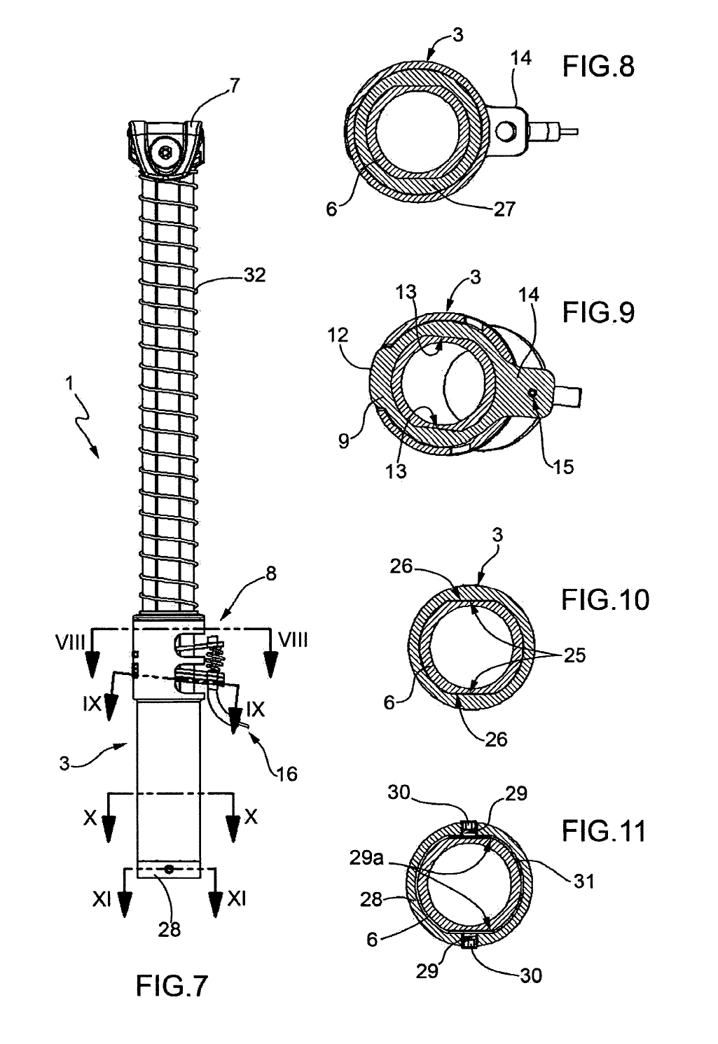

The jam means 8 are identical to those described in the previous embodiments, in particular of the embodiments shown in FIGS. 1-25, except for the sheath 19 of the operating cable 17, which is provided with a cable housing cap 58, and except for the head 18 of the operation cable 17, which is provided with a further housing cap 59.

Correspondingly, the holes provided in the operation portions 14 of the first and second jam rings 10,11 have an internal diameter suitable to create a loose fit with the cable housing cap 58 and with the further housing cap 59, to allow the jam rings 10,11 to pivot.

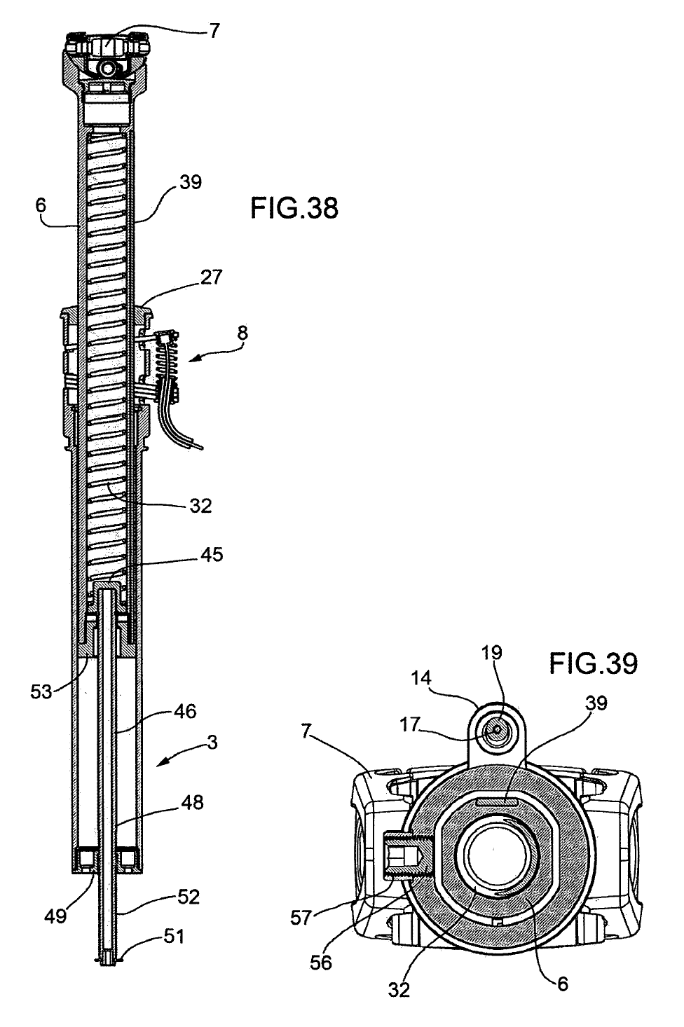

FIG. 38 shows the adjustable seat post assembly in a further possible configuration, in which the overall length of the seat post is conveniently shortened to user's liking.

In fact, FIG. 38 shows the seat post assembly of FIGS. 32-37 in which the stem 46 is partially lowered with respect to the end cap 49: more in detail, the external thread 52 of the stem 46 is screwed in the passing thread of the end cap 49 itself, for a certain length. In this way, the overall length of the seat post can be shortened, with respect to the configuration of FIG. 35, by a length which is equal to the screwed portion of the external thread 52 of the stem 46.

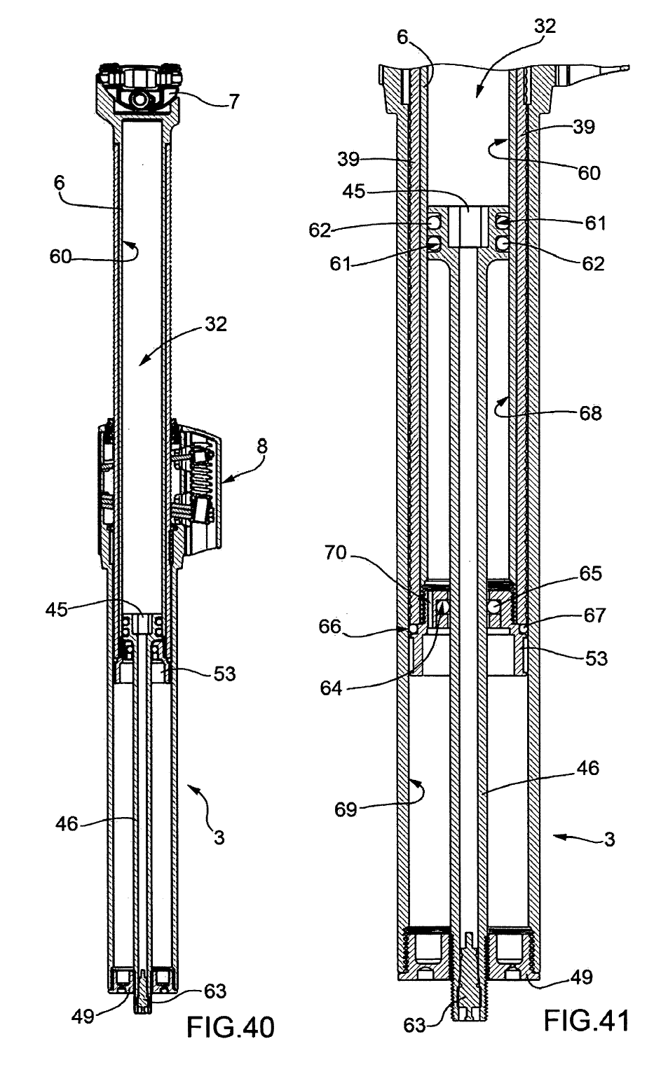

Another embodiment of the adjustable seat post assembly according to the invention is shown in FIGS. 40,41.

This further embodiment is similar to the embodiment, previously described, of FIGS. 32-39, except for the seat spring being used, which in this embodiment is an air spring, fully indicated with 32.

As shown in FIG. 40, the seat spring 32 comprises an internal cavity of the quill 6, defining an air cylinder 60; moreover, the seat spring 32 comprises a stem 46 with a head 45 provided with seats 61 for O-ring seals 62, realizing therefore a piston suitable to slide inside the air cylinder 60.

The air seat spring 32 comprises an air valve 63 of the known type.

The air valve 63 is inserted in the cavity of the stem 46, by its lower end.

The air valve 63 allows the user to pump air inside the cylinder 60 through the channel defined by the stem 46, using a typical bicycle pump or a shock pump.

The adjustable seat post assembly further comprises a damping element, which cooperates with the seat spring 32.

The damping element comprises a lower bushing 53 of the quill 6.

The lower bushing 53 comprises an internal seat 64 for an internal O-ring seal 65, which realizes an air-proof coupling with the external surface of the stem 45.

The lower bushing 53 further comprises and external seat 66 for an external O-ring seal 67, which realizes and air-proof coupling with the internal surface of the bushing 3.

As shown in FIG. 41, the internal O-ring seal 65 defines a first air chamber 68 inside the bushing 3, and a second air chamber 69 inside the cavity of the quill 6.

The first air chamber 68 and the second air chamber communicate through a small passing hole 70 provided in the lower bushing 53.

When the rider intends to raise the seat, he operates the jam means 8 in the way previously described.

The air pressure of the air cylinder 60 acts then on the head 45 of the stem 46 and forces the seat post to raise, until the user releases the jam means 8 back in the locked position.

Since the speed of the raising quill 6 could be too high, in order to prevent the seat from colliding with the rider's posterior, a damping effect is achieved by the passing hole 70. In fact, as the quill 6 is raised under air pressure of the cylinder 60, air pressure in the second air chamber 69 decreases, while air pressure in the first air chamber 68 increases.

Air then flows, through the passing hole 70, from the first air chamber 68 to the second air chamber 69.

The diameter of the passing hole 70 is small enough to cause a damping action.

After the quill 6 has stopped, air in the first air chamber 68 and in the second air chamber 69 is back at ambient pressure.

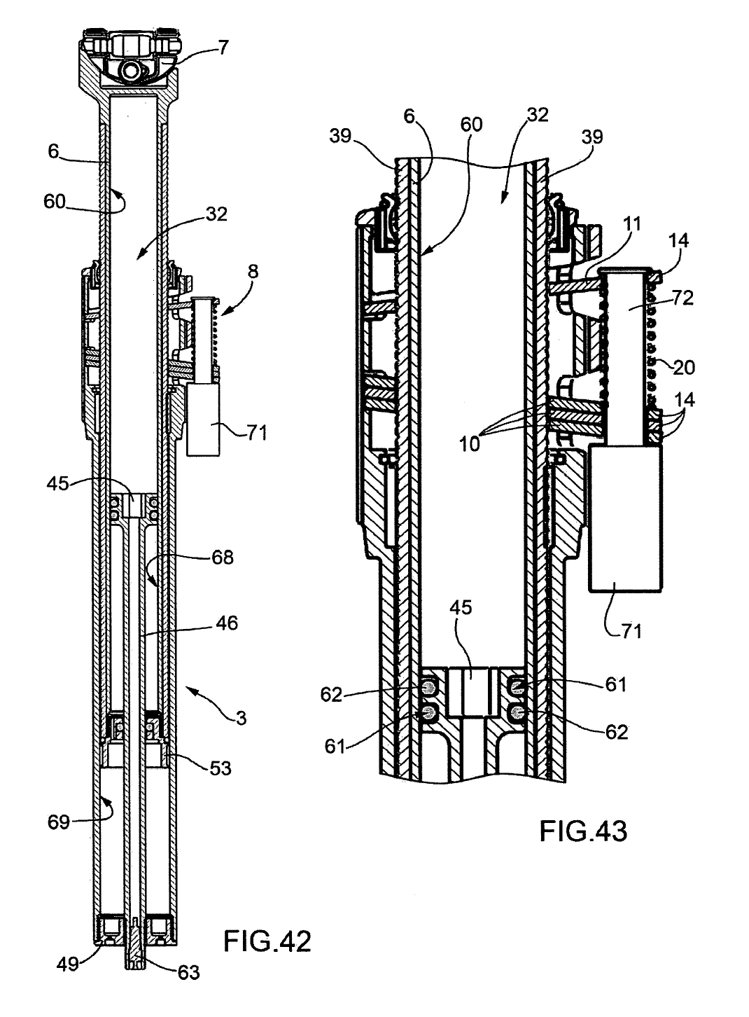

Another embodiment of the adjustable seat post assembly according to the invention is shown in FIGS. 42,43.

This embodiment is similar to the one previously described and represented in FIGS. 40,41, except for the fact that the jam means 8 are operated by an electric actuator.

More in detail, the electric actuator of the jam means 8 comprises a solenoid 71.

As shown in FIG. 43, the solenoid 71 comprises a rod 72 inserted in the holes 15 of the operation portions 14 of the jam rings 10,11.

The operation spring 20 is inserted along the rod 72 of the solenoid 71.

The solenoid 71 comprises a battery, not shown in figures but of the known type.

The solenoid 71 is preferably of the normally open kind: as shown in FIG. 43, in this position the jam means 8 are in the locked configuration.

When the user activates the solenoid 71, the jam means 8 are turned in the unlocked position, and the quill 6 of the seat post is raised by the air seat spring 32.

The solenoid 71 can be activated, for example, in many different ways.

In one embodiment of the invention, an activation button is provided on the solenoid 71. When pushed, the button excites the solenoid 71, which in turn pulls the jam rings 10,11 of the jam means 8 for raising or lowering the seat post.

In another embodiment of the invention an activation button is provided on the bicycle handlebar, and it is connected to the solenoid 71 through an electrical wire. The latter can be routed very discretely on the bicycle frame.

The battery could be mounted anywhere between the solenoid 71 and the activation button.

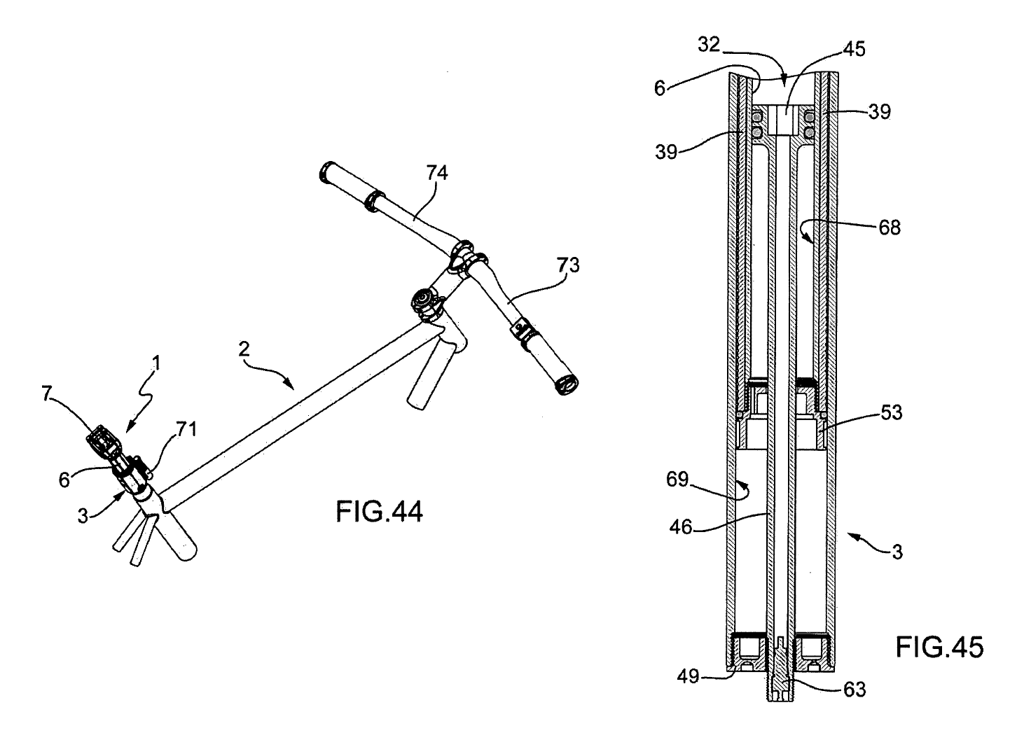

In another embodiment of the invention, shown in FIG. 44, an activation button 73 is mounted on the bicycle handlebar 74, connected to a battery and to a wireless transmitter: the battery and the transmitters are not shown in the figure, but are both of the known type.

A wireless receiver, not shown in FIG. 44, is mounted on the solenoid 71.

The solenoid 71 can therefore be activated without any electrical wire added to the bicycle frame.

Furthermore, the activation button 73 can be mounted anywhere on the frame, or in any other location which may be chosen by the rider.

The solenoid 71 provided with a wireless receiver can be operated by more than one activation button 73.

For example, two activation buttons 73 can be mounted on the handlebar 74, allowing the rider to operate the solenoid 71 either with left or right hand.

Another embodiment of the adjustable seat post assembly according to the present invention is shown in FIG. 45.

This embodiment is similar to those of FIGS. 40-44, except for the fact that a damping element is not provided.

In fact, no internal O-ring seal is provided in the lower bushing 53: therefore, there is a free air passage between the first air chamber 68 and the second air chamber 69.

This embodiment allows the rider to get a faster raising of the seat post, when necessary.

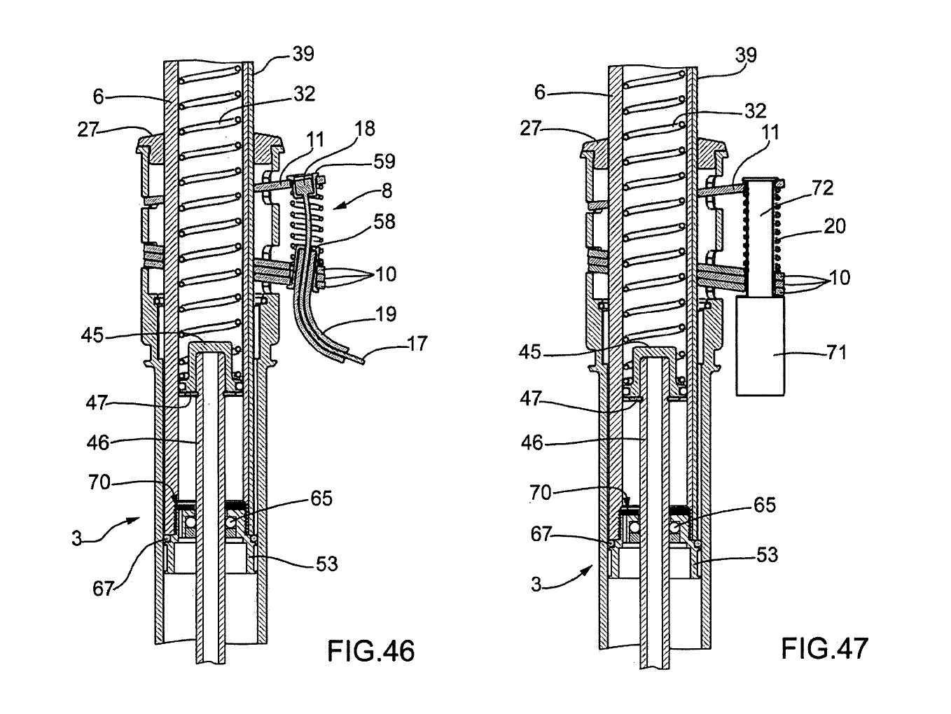

Another embodiment of the adjustable seat post assembly according to the invention is shown in FIG. 46.

This embodiment is similar to the one of FIGS. 32-39, i.e. it is provided with a coil seat spring 32, and it also provided with a damping element, as described for example in embodiment of FIGS. 40,41.

In fact, the lower bushing 53 is the same described in the embodiment of FIGS. 40,41, and it is provided with an internal O-ring seal 65, an external O-ring seal 67 and a passing hole 70, which connects a first air chamber 68 to a second air chamber 69.

Another embodiment of the adjustable seat post assembly according to the invention is shown in FIG. 47.

This embodiment is similar to the one represented in FIG. 46, except for the fact that the jam means 8 are operated by a solenoid 71, as described for the embodiment of FIGS. 42,43.

The present invention has been described according to preferred embodiments, but equivalent variants can be devised without departing from the scope of protection offered by the following claims.

1. An adjustable seat post assembly for bicycles and the like, comprising
a bushing;
a quill slidingly inserted in said bushing and supporting the seat;
jam means, inserted along said quill and having a portion which is pivotally coupled to said bushing;
said jam means being pivotable from an unlocked position, in which said quill can freely slide inside said jam means and relative to said bushing, to at least a locked position in which said jam means blocks said quill relative to said bushing in at least one direction of displacement.

2. The adjustable seat post assembly according to claim 1, in which said jam means comprises at least a first jam ring pivotable from an unlocked position, in which said quill can freely slide inside said first jam ring and relative to said bushing, to at least a locked position in which said first jam ring blocks said quill relative to said bushing in the downward direction.

3. The adjustable seat post assembly according to claim 2, in which said jam means comprises a group of said first jam rings.

4. The adjustable seat post assembly according to claim 3, in which said first jam rings are piled up along said quill.

5. The adjustable seat post assembly according to claim 1, in which said jam means comprises at least a second jam ring pivotable from an unlocked position, in which said quill can freely slide inside said second jam ring and relative to said bushing, to at least a locked position in which said second jam ring blocks said quill relative to said bushing in a second direction of displacement.

6. The adjustable seat post assembly according to claim 5, in which said second direction of displacement is upwards.

7. The adjustable seat post assembly according to claim 5, in which said first jam ring or said group of first jam rings and said second jam ring are pivotable according to respective opposite directions from said unlocked position to said locked position and vice versa.

8. The adjustable seat post assembly according to claim 1, in which said pivoting portion of said at least one jam ring comprises a sort of circular segment having a radius which is bigger than the radius of said jam rings.

9. The adjustable seat post assembly according to claim 1, in which said at least one jam ring comprises an operation portion opposite to said pivoting portion.

10. The adjustable seat post assembly according to claim 9, in which said operation portion of said at least one jam ring comprises connecting means to a remote control device.

11. The adjustable seat post assembly according to claim 10, in which said connecting means comprise a hole provided in said operation portion.

12. The adjustable seat post assembly according to claim 11, in which said remote control device comprises an operation cable passing through said hole, said operation cable having a head resting on said operation portion of said second jam ring and having a sheath whose end rests on said operation portion of said at least one first jam ring.

13. The adjustable seat post assembly according to claim 12, further comprising an operation spring provided between said at least one first jam ring and said second jam ring, inserted along said operation cable.

14. The adjustable seat post assembly according to claim 12, further comprising an operation spring provided between said at least one first jam ring and said second jam ring, inserted along said quill.

15. The adjustable seat post assembly according to claim 1, in which said bushing comprises a first slot for said pivoting portion of said at least one first jam ring.

16. The adjustable seat post assembly according to claim 15, in which said bushing comprises a second slot for said pivoting portion of said second jam ring.

17. The adjustable seat post assembly according to claim 1, in which said bushing comprises a first opening for the operation portion of said at least one first jam ring.

18. The adjustable seat post assembly according to claim 17, in which said bushing comprises a second opening for the operation portion of said second jam ring.

19. The adjustable seat post assembly according to claim 1, in which said quill comprises at least a substantially flat external surface, said bushing correspondingly comprising at least a substantially flat internal surface, coupled to said substantially flat external surface in order to prevent rotation between said bushing and said quill.

20. The adjustable seat post assembly according to claim 19, in which said quill comprises two opposite substantially flat external surfaces, said bushing correspondingly comprising at least two opposite substantially flat internal surfaces, respectively coupled to said substantially flat external surfaces, in order to prevent rotation between said bushing and said quill.

21. The adjustable seat post assembly according to claim 1, further comprising at least a height ring provided along said quill, suitable to selectively adjust the maximum height of the seat.

22. The adjustable seat post assembly according to claim 21, in which said height ring comprises at least a passing thread for a set screw suitable to engage said at least one substantially flat external surface of said quill.

23. The adjustable seat post assembly according to claim 1, further comprising at least a bushing wiper mounted on top of said bushing.

24. The adjustable seat post assembly according to claim 1, further comprising at least a seat spring suitable to determine the displacement of said quill in at least one direction.

25. The adjustable seat post assembly according to claim 24, in which said seat spring is inserted along said quill and provided between said bushing wiper and the head of said quill.

26. The adjustable seat post assembly according to claim 24, in which said spring is inserted along said quill and provided between said bushing and said height ring.

27. The adjustable seat post assembly according to claim 26, in which said seat spring has a first end engaged in a first housing provided in said bushing, and a second end engaged in a second housing provided in said height ring.

28. The adjustable seat post assembly according to claim 26, in which said seat spring has a first end screwed on to a first helical groove provided in said bushing, and a second end screwed on to a second helical groove provided in said height ring.

29. The adjustable seat post assembly according to claim 4, further comprising an operation spring provided between said at least one first jam ring and said bushing.

30. The adjustable seat post assembly according to claim 1, further comprising at least a jam strip mounted on the external surface of said quill.

31. The adjustable seat post assembly according to claim 30, in which said jam strip is provided with a plurality of transversal grooves suitable to be engaged by said at least one jam ring.

32. The adjustable seat post assembly according to claim 30, in which said jam strip has a smooth surface.

33. The adjustable seat assembly according to claim 30, in which said jam strip is engaged in a longitudinal closed slot provided in said quill.

34. The adjustable seat post assembly according to claim 30, in which said jam strip is engaged in a longitudinal open groove provided in said quill.

35. The adjustable seat post assembly according to claim 32, in which said jam strip is engaged in said longitudinal groove of said quill with a dovetail coupling.

36. The adjustable seat post assembly according to claim 24, in which said seat spring is contained within the quill.

37. The adjustable seat post assembly according to claim 36, in which said seat spring has an upper end resting on an internal collar of said quill, and a lower end resting on a head of a stem housed inside said bushing.

38. The adjustable seat post assembly according to claim 37, in which said stem has a lower extremity provided with an external thread which is screwed in a passing thread of and end cap of said bushing.

39. The adjustable seat post assembly according to claim 37, in which said quill has a lower bushing provided with a passing hole, in which said stem is slidingly engaged.

40. The adjustable seat post assembly according to claim 24, in which said seat spring is an air spring.

41. The adjustable seat post assembly according to the preceding claim, in which said seat spring comprises an internal cavity of said quill, defining an air cylinder.

42. The adjustable seat post assembly according to claim 41, in which said seat spring comprises a stem with a head provided with at least a seat for an O-ring seal, realizing therefore a piston suitable to slide inside the air cylinder.

43. The adjustable seat post assembly according to claim 24, further comprising a damping element which cooperates with said seat spring.

44. The adjustable seat post assembly according to claim 43, in which said damping element comprises a lower bushing of said quill, provided with seals which define a first air chamber and a second air chamber connected by a passing hole suitable to achieve a damping effect.

45. The adjustable seat post assembly according to claim 2, further comprising an electric actuator of said jam means.

46. The adjustable seat post assembly according to claim 45, in which said electric actuator comprises a solenoid.

47. The adjustable seat post assembly according to claim 46, in which said solenoid comprises a rod of said operation portions of said jam rings.
